(19) United States
(12) Patent Application Publication
(10) Pub. No.: US 2006/0226184 A1
(43) Pub. Date: Oct. 12, 2006

(54) Thumb Activator

(76) Inventor: Marsha Ann Karzmer, Youngstown, OH (US)

Correspondence Address: Brian Johnson, 21778 Scenic Pointe, Strongsville, OH, 44149, US

(21) Appl. No.: 11/279,038

(22) Filed: Apr. 7, 2006

Related U.S. Application Data
(60) Provisional application No. 60/668,954, filed on Apr. 7, 2005.

(51) Int. Cl. A41D 19/00; A61C 19/00

(52) U.S. Cl. 224/217

(57) ABSTRACT

A thumb activator having an annular band and an activation stylus extension extending angularly from the outer surface of the annular band.

### CROSS-REFERENCE TO RELATED APPLICATIONS

This application claims priority to U.S. Provisional Patent Application Number 60/668,954 filed on Apr. 7, 2005, the entire disclosure of which is fully incorporated herein by reference.

### BACKGROUND

Buttons on portable electronic devices, such as a personal data assistant, are small and difficult to actuate. PDA users must user their fingers, pointing devices or their thumbs to actuate buttons. Use of fingers is undesirable as the user's fingers usually hold the device, making them inappropriate for button actuation. Pointing devices are clumsy, awkward and easy to loose. Thumbs are well-positioned for button actuation, but are usually too large to effectively press only one button at a time.

### SUMMARY

A thumb activator is provided. The activator includes an annular band and an activator stylus extension extending angularly from the outer surface of the annular band.

### DESCRIPTION OF THE DRAWINGS

FIG. 1 is a perspective view of an exemplary embodiment of a thumb activator.

FIG. 2 is a front elevational view of an exemplary embodiment of a thumb activator.

FIG. 3 is a right side elevational view an exemplary embodiment of a thumb activator,

FIG. 4 is a side elevational view of an exemplary embodiment of a thumb activator positioned in use on an operator's thumb.

FIG. 5 is a front elevational view of an exemplary embodiment of a thumb activator in extended pre-application position.

FIG. 6 is a top and side view of an exemplary embodiment of a thumb activator.

FIG. 7 is a perspective view of a portion of an exemplary embodiment of a thumb activator.

FIG. 8 is a perspective view of an exemplary embodiment of a thumb activator.

### DETAILED DESCRIPTION

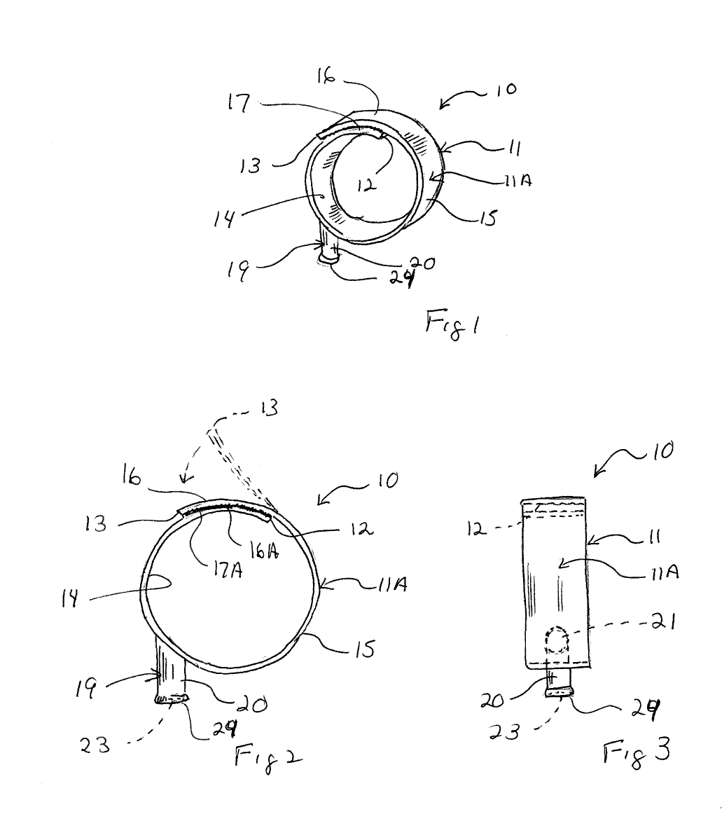

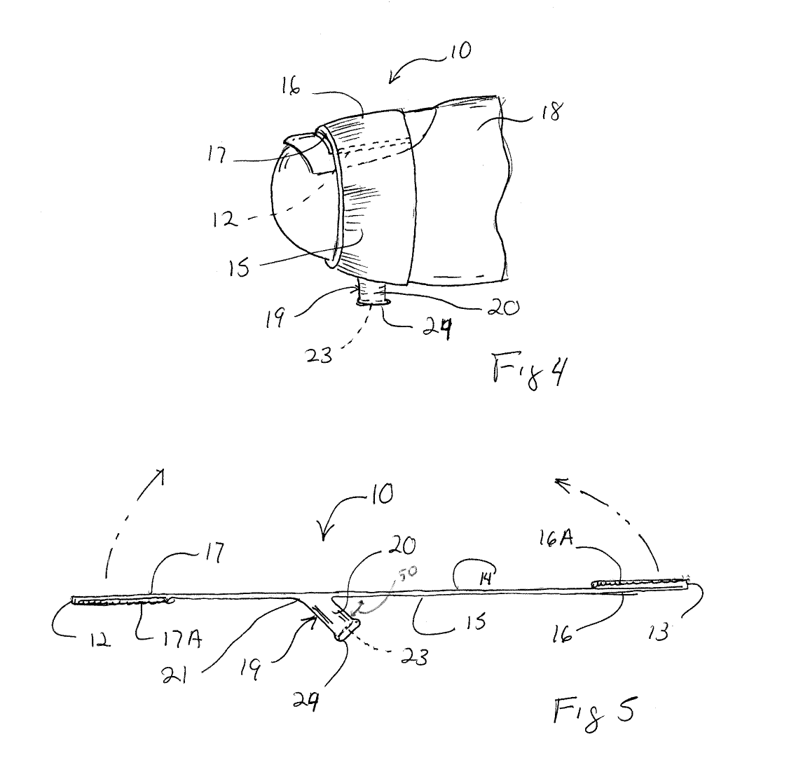

An exemplary thumb activator is provided. Referring to FIGS. 1-3, thumb activator 10 has a main body member 11 defining an annular band 11A having oppositely disposed free ends 12 and 13. The band 11A has an inner thumb engagement surface 14 and an outer surface 15.

Annular band 11A has a size adjustor for adjusting the circumference of the band. With reference to FIG. 1, an exemplary size adjustor includes an engagement mechanism located upon, or optionally integral with, at least one or both free ends 12 and 13. In this example, free ends 12 and 13 have an engagement mechanism for engaging each other including interlocking overlapping engagement surface areas 16 and 17 extending inwardly from the respective free ends 12 and 13.

Each of the engagement surface areas 16 and 17 have corresponding hook and loop material 16A and 17A, for example thereon for selective registration with one another. The band 11A is therefore adjustable to different size engagement depending on the user's thumb 18 as best seen in FIG. 4 of the drawings. The remaining outer surface 15 of the band is of a dimension to afford surface imprinting of selected indicia thereon and would typically be made from synthetic resin material in accordance with those imprinting properties, although it will be appreciated that any suitable material is optionally used.

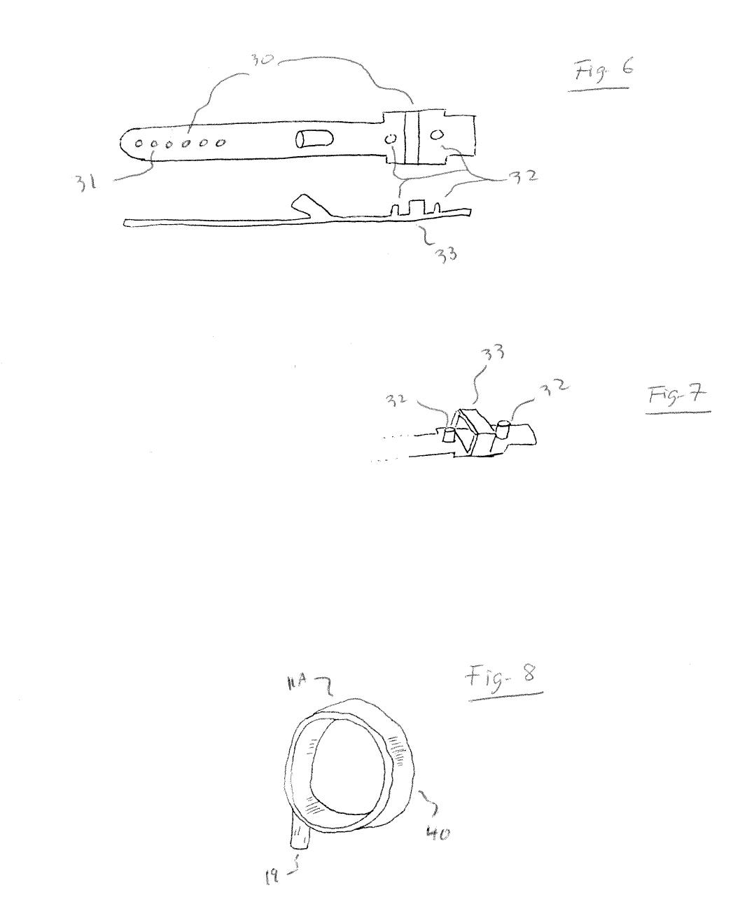

With reference to FIGS. 6 and 7, another exemplary size adjustor is illustrated. Size adjustor includes engagement mechanism 30. Engagement mechanism 30 is a pin mechanism, including one or more notches 31 in one free end and one or more pins 32 in the other free end. In use, the annular band is wrapped in a manner wherein the pins extend from the out surface of the band and the notches are placed over the pins whereby one or more pins engages one or more notches. The size of the band is thus adjustable depending upon which pin is placed in which notch.

With reference to FIGS. 6 and 7, engagement mechanism 30 optionally includes frame 33. Frame 33 is sized to receive a free end. Frame 33 operates to maintain the free end with the notches over the pins. Frame 33 optionally operates as a buckle.

While the size adjustor and the engagement mechanism have been illustrated as a hook and loop mechanism and as a notch and pin mechanism, it will be appreciated that any construct is usable which is capable of engaging one free end in disposition with the other free end, whereby the size of the annual ring is reasonably maintained. Other such exemplary adjustors/engagement mechanisms include, but are not limited to, frictional engagement, static electricity engagement, magnetic engagement, adhesive, chemical bonding, clasps, buttons, ties and the like.

With reference to FIG. 8, in an embodiment annual band 11A is an elastic band 40 having an outer surface and an activator stylus extension 19, or a nub, extending angularly from the outer surface of the annual band 11A. Elastic band 40 is optionally integral and capable of stretching or expanding for a comfortable, snug fit on a user's thumb. Elastic band 40 is made of any suitable elastic material or compound therewith, including but not limited to rubber or synthetic rubber.

With reference again to FIGS. 1 through 5, an activation stylus extension 19 extends angularly from and is integral with the main body member 11, with band's 11A remaining outer surface 15 optionally in disposing relation to the overlapping engaged free ends 12 and 13 as hereinbefore described.

The activation stylus extension, or nub, 19 is any shape and size suitable for activating one or more buttons on a portable electronic device. Extension 19 is optionally integrally molded of the same material of the band 11A and optionally defines a cylinder body member 20 with the distal end 21 being cross-sectionally ovaloid. The oppositely disposed free end 22 thereof optionally has a concave surface at 23 defining an enlarged annular end at 24. While extension 19 has been described herein as generally cylindrical in nature, it will be appreciated that extension 19 is any suitable shape and size, such as a polygon in cross-section (i.e., square or rectangular in cross-section, or irregular in shape in cross-section). Furthermore, free end 22 has any suitable shape and size, and need not be concave. Free end 22 may be, e.g., flat or convex, with or without a textured surface thereon to lessen slipping off of a key.

Referring to FIG. 5 of the drawings, the thumb activator 10 can be seen in non-thumb engagement position when molded of synthetic resin material. An engagement mechanism, here hook and loop material 16A and 17A, is applied to the oppositely disposed end surface areas 16 and 17, as noted, for adjustable overlapping engagement when applied around the thumb 18 as best seen in FIG. 4 of the drawings.

It will be evident from the foregoing description that the stylus extension 19 will provide a precise equipment engagement application surface at 24 on the free end thereof, which is optionally textured. Additionally, the performance characteristics of the so formed synthetic resin material will allow the activator 10 to have limited yield under external force input so that the band portion 11A of the main body member 11 will be compliant to conform under minimal force about the contours of the user's thumb 18 as it is positioned there around and selectively secured upon itself as hereinbefore described.

The stylus portion 19 will not deflect or deform under normal component engagement force as it selectively engages the data input control surfaces and will also be of a surface quality to avoid slipping when in use.

The angular offset alignment of the engagement stylus extension 19 in relation to the band portion 11A will afford a visual confirmation to the user for accuracy and use which will become a distinctive after repetitive operation.

With reference to FIG. 5, extension 19 extends from the outer surface of band 11A at any suitable angle 50. Angle 50 is optionally 90 degrees, with extension 19 normal to the outer surface of band 11A. Angle 50 is optionally between about 89 degrees and about 1 degree. In an embodiment, angle 50 is between about 60 degrees and about 30 degrees. In another embodiment, angle 50 is about 45 degrees.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I claim:

1. A thumb activator, comprising:
an annular band having oppositely disposed free ends, the free ends having an engagement means for engagement with each other; and
an activation stylus extension extending angularly from the outer surface of the annular band.

2. The thumb activator of claim 1, wherein the engagement means includes hook and loop material.

3. The thumb activator of claim 2, wherein one free end includes hook material for engaging loop material on the other free end.

4. The thumb activator of claim 1, wherein the engagement means includes a buckling means.

5. The thumb activator of claim 1, wherein the first free end includes at least one notch and the second free end includes at least one pin for engaging the notch.

6. The thumb activator of claim 5, wherein the first free end includes a plurality of notches.

7. The thumb activator of claim 6, wherein the second free end includes a plurality of pins.

8. The thumb activator of claim 5, wherein the second free end includes at least one frame for accepting the first free end.

9. The thumb activator of claim 1, wherein the activation stylus extension is generally cylindrical in shape.

10. The thumb activator of claim 1, wherein the activation stylus extension is a nub.

11. The thumb activator of claim 1, wherein the activation stylus extension extends from the outer surface at an angle of between about 89 degrees and about 1 degree.

12. The thumb activator of claim 11, wherein the activation stylus extension extends from the outer surface at an angle of between about 60 degrees and about 30 degrees.

13. The thumb activator of claim 12, wherein the activation stylus extension extends from the outer surface at an angle of about 45 degrees.

14. The thumb activator of claim 1, wherein the activation stylus extension is normal to the outer surface.

15. An actuator for placement on a thumb, the actuator comprising:
an annular band having an outer surface and a size adjustor; and
a nub extending angularly from the outer surface.

16. The actuator of claim 15, wherein the size adjustor includes:
hook material on a first end of the annular band; and
loop material on a second end of the annular band.

17. The actuator of claim 15, wherein the size adjustor includes at least one notch and pin.

18. The actuator of claim 15, wherein the size adjustor includes at least one buckle.

19. The actuator of claim 15, wherein the nub has a free end including a textured surface,

20. A thumb activator comprising:
an elastic annular band having an outer surface and a nub extending angularly from the outer surface.
